(19) United States
(12) Patent Application Publication
(10) Pub. No.: US 2019/0179985 A1
(43) Pub. Date: Jun. 13, 2019

(54) A DESIGN OPTIMIZATION METHOD FOR PREVENTING WRINKLING OF STRETCHED MEMBRANE STRUCTURES

(71) Applicant: DALIAN UNIVERSITY OF TECHNOLOGY

(72) Inventors: Yangjun LUO, Dalian City, Liaoning Province (CN); Zhan KANG, Dalian City, Liaoning Province (CN); Ming LI, Dalian City, Liaoning Province (CN)

(21) Appl. No.: 16/084,053

(22) PCT Filed: Jan. 9, 2017
(86) PCT No.: PCT/CN2017/070594

§ 371 Date: Sep. 11, 2018

(51) Int. Cl. G06F 17/50

(52) U.S. Cl. CPC G06F 17/5018; G06F 2217/06

(57) ABSTRACT

The present invention proposes a design optimization method to prevent wrinkling of stretched membrane structures. It solves the problem of membrane wrinkling in a macro structure or a graphene structure under stretching loads. The membrane material distribution is found using a topology optimization technique that generates a design with curved boundaries or inner holes to eliminate wrinkles. The stress state of a membrane is regulated by restrict the minimum principal stress of each finite-element to a positive value. Such a method guarantees that wrinkling is prevented by accurately designing the shape of boundary and the layout of holes of the membrane. The optimization procedure is highly automated, and the efficiency of the wrinkle-free design for membrane structures can be guaranteed.

### TECHNICAL FIELD

The present invention proposes a design optimization method to prevent wrinkling of stretched membrane structures. It belongs to the technical fields of aerospace-membrane structural design and graphene/nano-material structural design. In the present invention, a novel optimization model-based method is used to introduce curved boundary and inner holes of a thin membrane structure. This regulates and controls the principal stress distribution of the membrane structure under a stretching load, thereby effectively suppress wrinkling that may otherwise occur in the membrane, and completely achieving a wrinkle-free design of membrane-type structures.

### BACKGROUND

With the development of technology and the progress of human civilization, membrane structures have been used increasingly as a structural form for aerospace structures, such as solar sails, radar antennas, inflatable reflectors, and sun shields. These structures utilize the advantages of easy folding/unfolding and light weight, so that the conflict between the limited carrying capacity of a rocket vehicle and the ever-increasing requirements of large size and large caliber can be solved, thereby offering attractive application prospects. However, due to low bending stiffness, thin membranes are prone to out-of-plane buckling (i.e., wrinkling) even under tension. In aerospace applications, it is often necessary for the membrane to maintain a smooth surface. For example, in a film reflector, the fixed boundary condition can easily cause localized wrinkles, which may affect the reflection of surface light and reduce the accuracy of imaging. When subjected to a concentrated force, the four corners of a solar sail also exhibits wrinkles, affecting the photon reflection angle and the direction of solar photon pressure. Moreover, large wrinkles may result in a local concentration of photon energy, causing localized high temperatures, producing creep, and affecting the membrane service life. Therefore, effectively preventing wrinkles in membranes is of particular importance in aerospace applications.

Also, in the field of nano-materials, grapheme is the thinnest and strongest novel nanomaterial with the best electrical and thermal conduction performance discovered to date. Graphene is often referred to by scientists as “the king of novel materials” which is “thoroughly changing the twenty-first century”. It possesses great development potential in the fields of mobile devices, aerospace, and new energy batteries. Graphene has a quasi-two-dimensional material structure that is only one atomic layer thick (˜0.335 nm) and has mechanical properties very similar to a flat membrane. Under a stretching force, it may be subjected to out-of-plane wrinkling, which may affect the electrical and mechanical properties, among others. Therefore, it is also necessary to prevent wrinkling in graphene structures for many applications.

Essentially, membrane wrinkling is a highly nonlinear post-buckling phenomenon that may be prevented by controlling the stress state through changing the external loads and boundary conditions in the architectural engineering. However, it is almost impossible to do so with a space structure or a nano-material (e.g., graphene) structure because of limitations in aspects such as spatial expansion, weight, and nanometer manufacturing technology. Therefore, it is a challenging problem to suppress wrinkling by changing only the topology and shape of the structure without changing the external loads and boundary conditions. In some existing research and engineering applications, shape design is performed on simple membrane structures using trial-and-error approach, which cannot be generalized. For membrane structures with complex loads or boundaries, there is an urgent need to develop a generic design optimization method to prevent wrinkling completely. This involves automatically, accurately, and efficiently seeking an innovative topological form that generates wrinkle-free design of membrane structures.

### SUMMARY

This invention proposes a design optimization method to prevent wrinkling of a membrane structure. It solves the problem of membrane wrinkling under a stretching load. The membrane material distribution is found using a topology optimization technique that generates a design with curved boundaries or inner holes to eliminate wrinkles. The stress state of a membrane is regulated by restrict the minimum principal stress of each element to a positive value. Such a method guarantees that wrinkling is prevented by accurately designing the shape of boundary and the layout of holes of the membrane. The optimization procedure is highly automated, and the efficiency of the wrinkle-free design for membrane structures can be guaranteed.

The proposed design optimization method for preventing wrinkling of a stretched membrane structure consists of the following steps:

### Step 1: Perform Wrinkle Free Topology Optimization on a Membrane Structure

(a) Determine a design domain according to the size requirements and actual load conditions of the structure, and establish an initial design of the topology optimization of the membrane structure. Furthermore, apply a load and a constraint boundary, and discretize the design domain into finite-element meshes.
(b) Establish a wrinkle-free topology optimization model of the membrane structure:
   (i) Design objective: to maximize overall stiffness of the membrane structure or minimize overall compliance.
   (ii) Constraint 1: the minimum principal stress of each finite element is required to be positive (i.e., σ₁^{e}>0, σ₂^{e}>0), where e refers to the serial number of the finite element, σ₁ refers to the maximum principal stress, and σ₂ refers to the minimum principal stress.
   (iii) Constraint 2: the used membrane area is determined as the area constraint limit. The used membrane area is 60%-90% of the area of the design domain.
   (iv) Design variables: the relative density of an element in the design domain is ρₑ, and the value of ρₑ is between 0.001 and 1, which represents the distribution of membrane material at the element.
(c) According to the topology optimization model established in step 1(b), equivalently convert Constraint 1 into I₁>\sqrt{3J₂}, where I₁ and J₂ are the first and second invariants of the stress, respectively.
(d) Perform constraint relaxation processing on the converted constraint in step 1(c) to avoid a singular stress solution. A cosine-type relaxation method is used, wherein the relaxation function is θ=(1−cos (ρₑ·π))/2 .
(e) Perform iterative solution on the optimization model using the SIMP (Solid Isotropic Material with Penalization) method and optimization algorithm to obtain the optimal material distribution of the membrane structure.

### Step 2: Perform Detailed Shape Optimization Design on the Membrane Structure

On the basis of the membrane topology obtained in step 1(e), optimize specific geometric parameters of the boundary and holes of the membrane structure, considering the constraint of the minimum principal stress to obtain more detailed and accurate structural shape parameters.

The present invention has the following advantages. Before optimization, this type of membrane structure has a large area of obvious wrinkles under the action of stretching loads. After using the present invention to obtain a wrinkle-free structure, the minimum principal stress of the whole membrane is guaranteed to be a positive value through numerical simulation and test assessment, so that no wrinkling will occur. The optimized structure is easy to manufacture, and only simple cutting and holing are needed. Meanwhile, the wrinkle-free optimization method established in the present invention avoids complicated post-buckling analysis during the optimization process, which significantly improves the design efficiency. The present invention is expected to become an effective method for innovatively design of membrane structures in the fields of aerospace and micro/nano technology.

### DESCRIPTION OF THE DRAWINGS

FIG. 1 shows a design domain of a four-cornered stretched structure provided in an embodiment of the present invention.

FIG. 2(a) is an optimization design diagram of a four-cornered stretched structure when the membrane area ratio is 70%.

FIG. 2(b) is an optimization design diagram of a four-cornered stretched structure when the membrane area ratio is 80%.

FIG. 3 shows a design domain of a two-sided stretched structure with embedded rigid block provided in an embodiment of the present invention.

FIG. 4 is an optimization design diagram of a two-sided stretched structure with embedded rigid block when the membrane area ratio is 80%.

### DETAILED DESCRIPTION

Specific embodiments of the present invention are described in detail below in combination with the technical solution and accompanying drawings.

### Step 1: Perform Wrinkle Free Topology Optimization on a Membrane Structure

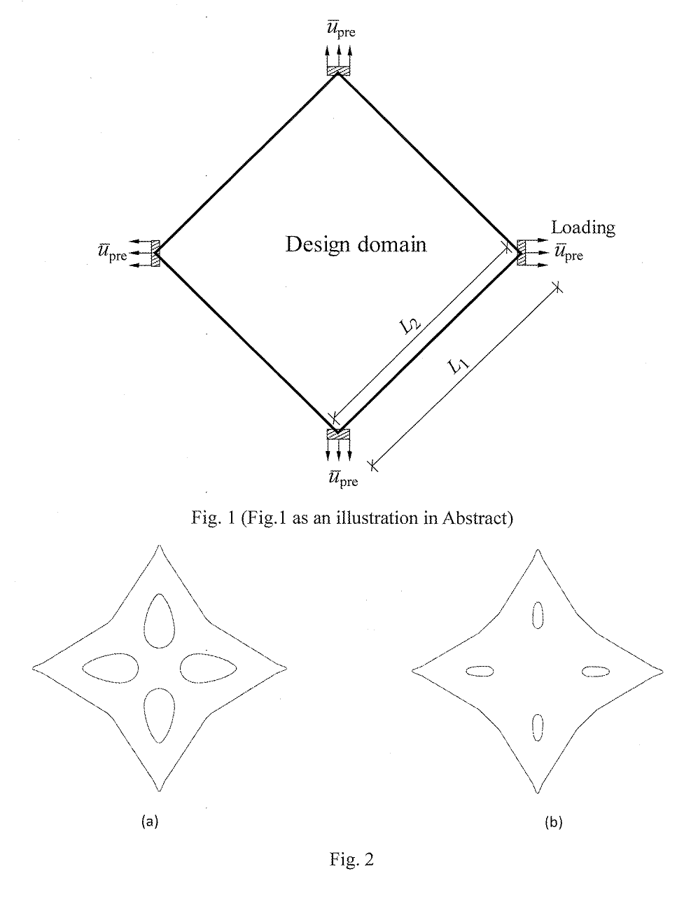

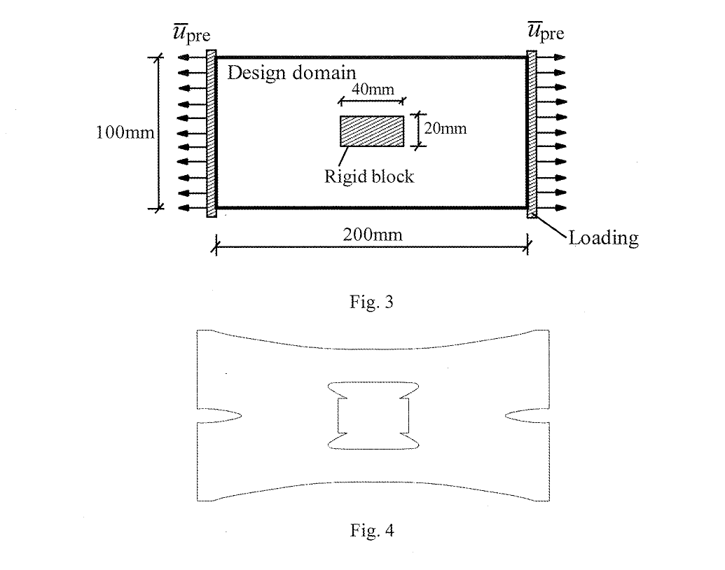

(a) Determine a design domain according to the size requirements and actual load conditions of the structure, and establish an initial design of the topology optimization of the membrane structure. Furthermore, apply a load and a constraint boundary, and discretize the design domain into finite-element meshes. FIG. 1 shows a design domain of a four-cornered stretched structure. The number N of the divided finite-element meshes is 6,400. FIG. 3 shows a design domain of a two-sided stretched structure with an embedded rigid block in the middle; here, we have N=5,000. Both initial structures show obvious wrinkling under the action of the stretching load.
(b) Establish a wrinkle-free topology optimization model of the membrane structure:
   (i) Design objective: to maximize overall stiffness of the membrane structure or minimize overall compliance.
   (ii) Constraint 1: the minimum principal stress of each finite element is required to be positive (i.e., σ₁^{e}>0, σ₂^{e}>0), where e refers to the serial number of the finite element, σ₁ refers to the maximum principal stress, and σ₂ refers to the minimum principal stress.
   (iii) Constraint 2: the used membrane area is determined as the area constraint limit. Here, the used membrane area is 70% or 80% of the area of the whole design domain.
   (iv) Design variables: the relative density of an element in the design domain is ρₑ, and the value of ρₑ is between 0.001 and 1, which represents the distribution of membrane material at the element.
(c) According to the topology optimization model established in step 1(b), equivalently convert Constraint 1 into I₁>\sqrt{3J₂}, where I₁ and J₂ are the first and second invariants of the stress, respectively.
(d) Perform constraint relaxation processing on the converted constraint in step 1(c) to avoid a singular stress solution. A cosine-type relaxation method is used, wherein the relaxation function is θ=(1−cos(ηₑ·π))/2 .
(e) Perform iterative solution on the optimization model using the SIMP (Solid Isotropic Material with Penalization) method and optimization algorithm to obtain the optimal material distribution of the membrane structure; see FIGS. 2 and 4, respectively.

### Step 2: Perform Detailed Shape Optimization Design on the Membrane Structure

On the basis of the membrane topology obtained in step 1(e), optimize specific geometric parameters of the boundary and holes of the membrane structure, considering the constraint of the minimum principal stress to obtain more detailed and accurate structural shape parameters.

The obtained structure is simple to manufacture. Through nonlinear post-buckling finite-element analysis and real-size test verification, no wrinkles are observed in the entire membrane structure, which verifies the method proposed in the present invention.

The essence of the present invention is to use the topology optimization method to obtain an optimal structure with a curved edge boundary or inner holes. By controlling and optimizing the minimum principal stress of the entire membrane, the purpose of wrinkle-free design is achieved. Any methods that simply modify the optimization model and method in step 1 (e.g., using a level set or explicit curve to describe the boundary and holes of the structure, using other topology optimization methods, or changing the objective function or specific forms of constraints) do not, deviate from the scope of the present invention.

1. A design optimization method for preventing wrinkling of a stretched membrane structure, comprising the following steps:
Step 1: Perform Wrinkle-Free Topology Optimization on a Membrane Structure
(a) Determine a design domain according to size requirements and actual load conditions of the structure, and establish an initial design of the topology optimization of the membrane structure; furthermore, apply a load and a constraint boundary, and discretize the design domain into finite-element meshes;
(b) Establish a wrinkle-free topology optimization model of the membrane structure:
(i) Design objective: to maximize overall stiffness of the membrane structure or minimize overall compliance;
(ii) Constraint 1: the minimum principal stress of each finite element is required to be positive, σ₁^{e}>0, σ₂^{e}>0, where e refers to the serial number of the finite element, σ₁ refers to the maximum principal stress, and σ₂ refers to the minimum principal stress;
(iii) Constraint 2: the used membrane area is determined as the area constraint limit; The used membrane area is 60%-90% of the area of the design domain;
(iv) Design variable: the relative density of an element in the design domain is ρₑ, and the value of ρₑ is between 0.001 and 1, which represents the distribution of membrane material at the element;
(c) According to the topology optimization model established in step 1(b), equivalently convert Constraint 1 into I₁>\sqrt{3J₂}, where I₁ and J₂ are first and second invariants of the stress, respectively;
(d) Perform constraint relaxation processing on the converted constraint in step 1(c) to avoid a singular stress solution;
(e) Perform iterative solution on the optimization model using the SIMP method and optimization algorithm to obtain the optimal material distribution of the membrane structure;
Step 2: Perform Detailed Shape Optimization Design on the Membrane Structure
On the basis of the membrane topology obtained in step 1(e), optimize specific geometric parameters of the boundary and holes of the membrane structure, considering the constraint of the minimum principal stress to obtain more detailed and accurate structure shape parameters.

2. The design optimization method according to claim 1, wherein the constraint relaxation processing in step 1 comprises a ε relaxation method and a qp relaxation method.

3. The design optimization method according to claim 1, wherein the constraint relaxation processing comprises a cosine-type relaxation method, wherein the relaxation function is θ=(1−cos(ρₑ·π))/2 .

4. The design optimization method according to claim 1, wherein the optimization algorithm is a criteria method, a MMA algorithm, an ESO method or a Level set method.
